(19) United States
(12) Patent Application Publication
(10) Pub. No.: US 2006/0185950 A1
(43) Pub. Date: Aug. 24, 2006

(54) Movement damper

(76) Inventor: Anton Gaile, Leutkirch (DE)

Correspondence Address: DILWORTH & BARRESE, LLP, 333 EARLE OVINGTON BLVD., UNIONDALE, NY, 11553, US

(21) Appl. No.: 11/299,472

(22) Filed: Dec. 12, 2005

(30) Foreign Application Priority Data
Dec. 10, 2004 (DE) 10 2004 059 653.0

(51) Int. Cl. F16F 9/00

(52) U.S. Cl. 188/316

(57) ABSTRACT

The present invention relates to a movement damper for vehicle chassis, in particular rail vehicles, comprising a damper housing in which a damper piston is movably received. In accordance with the invention, the movement damper is characterized in that a sensor for the detection of the movement and/or position of the damper piston relative to the damper housing is arranged in the interior of the damper housing.

The present invention relates to a movement damper for vehicle chassis, in particular rail vehicles, comprising a damper housing in which a damper piston is movably received.

A damper of this type is known, for example, from DE 103 06 564 B3 and is as a rule used to absorb impacts and movements in chassis of rail vehicles in order to damp movements of the running gear with respect to the vehicle chassis. It is customary for a number of reasons with chassis of this type to detect movements of the running gear with respect to the vehicle chassis, for example in order to be able to carry out a regulation of the vehicle level from the corresponding length or height information. They can, however, optionally also be used for the active control of the movement damper or to detect the course of the route. Conventionally, sensors are attached to the running gear for this purpose which are, however, very expensive and nevertheless unreliable.

It is therefore the underlying object of the invention to provide an improved damper of the said kind which avoids disadvantages of the prior art and further develops the latter in an advantageous manner. The detection of the movement or position of the running gear with respect to the vehicle chassis should preferably be improved with the movement damper.

This object is solved in accordance with the invention by a movement damper in accordance with claim 1. Preferred aspects are the subject of the dependent claims.

In accordance with the invention, a sensor is therefore integrated into the movement damper which detects the movement and/or the position of the damper piston, or of a piston rod connected thereto, relative to the damper housing. The desired height or length information can be derived from the information on the movement or position of the damper piston relative to the damper housing. The sensor is received in the interior of the damper housing and is hereby ideally protected mechanically with respect to environmental influences such as ice, snow, sand, dust or the like as well as from mechanical damage. The previously existing reliability problems can hereby be eliminated.

In addition, no additional installation space is required due to the integration of the path sensor or position sensor into the interior space of the damper, but rather the already available construction space is utilized. Additional mounting points can be dispensed with. In addition, the arrangement of the sensor in the movement damper is ideally suited for retrofitting since the mounting consoles for the damper are already present.

A substantially simpler and so more favorably priced sensor type can above all be used by the arrangement of the sensor in the interior of the damper. The costs of the damper with an integrated path sensor are comparable to a sensor with a similar mechanical design without a damper function. In addition, it cannot be neglected that better electromagnetic compatibility is achieved by the integration of the sensor into the movement damper.

The sensor and the movement damper are advantageously not connected to form an inseparable unit. The sensor can be arranged in a separately removable manner in the damper housing. The sensor can hereby be removed and reused on a defect of the damper and, vice versa, on a defect of the sensor, only this can be replaced.

The sensor itself can have different designs. It can work according to different active principles. For instance, an inductive sensor can be provided for the path detection or equally a capacitive sensor. The sensor can also work optoelectronically or acoustically, in particular with ultrasound. A sensor working according to the potentiometer principle can also be used.

In accordance with an advantageous embodiment of the invention, the sensor has a transducer as well as a position encoder cooperating therewith, of which the one is fastened to the damper housing and the other is connected to the damper piston so that a movement of the damper piston relative to the damper housing generates a corresponding movement of the transducer relative to the position encoder of the sensor. The damper housing can form a cylinder in a manner known per se in which the damper piston connected to a piston rod is seated in an axially displaceable manner. In accordance with an advantageous embodiment of the invention, the position encoder of the sensor can be fastened to the end face base of the cylindrical damper housing, whereas the transducer is seated on the end face of the damper piston and/or of the piston rod connected thereto facing this base. It is understood that the arrangement can generally also be reversed, i.e. that the transducer is seated at the end face base of the cylinder, whereas the position encoder is arranged at the piston side or the piston rod side. The previously described arrangement, however, brings along advantages, e.g. with respect to the detectable stroke and to the signal leads.

To provide a sensor arrangement of small size with nevertheless large detectable strokes, in accordance with a particularly advantageous embodiment of the invention, the piston rod can have an axial bore and the sensor can have a pick-up rod fastened to the damper housing over which the piston rod with the axial bore can be pushed so that the pick-up rod moves into the axial bore of the piston rod. If the transducer cooperating with the pick-up rod is seated at the piston or at an end of the piston rod projecting therefrom, large strokes can be detected without impairing the usable construction space of the cylinder.

In accordance with an advantageous embodiment of the invention, the transducer can have a sender sleeve which is seated on the piston rod and which is penetrated by the pick-up rod. It is, however, understood that differently shaped sender pieces can also be provided.

The sensor signal which is generated in the interior of the movement damper and which reproduces the position of the damper piston relative to the damper housing can be used for different purposes and be further processed. The sensor signal can in particular serve a height detection for level control systems and/or for pneumatic or hydropneumatic suspension systems. Alternatively or additionally, the sensor signal can be used for the active damper control. The damper can form a primary damper, a secondary damper or a transverse damper. It is likewise possible to implement a path detection by the integrated sensor for rotary dampers, coupling dampers or anti-rolling dampers and to use it for the detection of the track route and/or for the detection of disturbance variables such as the bracing of the system.

The invention will be explained in more detail in the following with respect to a preferred embodiment and to an associated drawing. There is shown in the drawing:

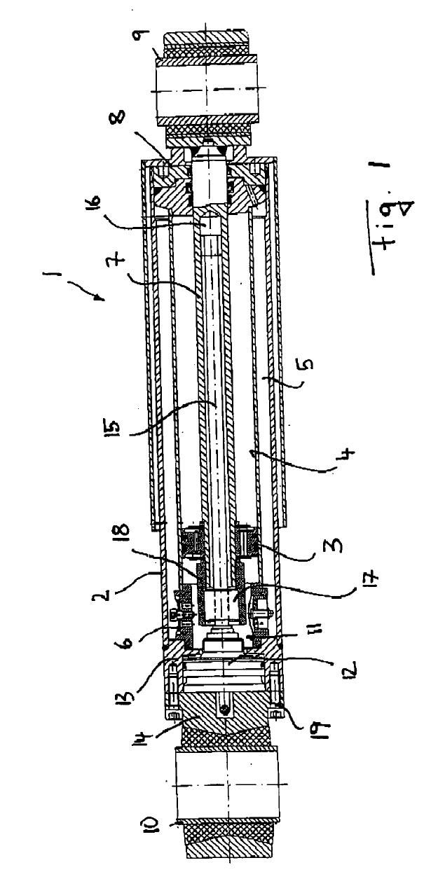

FIG. 1: a longitudinal section through a movement damper with an integrated path sensor in accordance with an advantageous embodiment of the invention which can be used in the chassis of a rail vehicle, optionally also in a road truck.

The movement damper 1 shown in FIG. 1 is made as a twin-tube damper. The damper housing 2 forms a cylinder 4 and an annular space 5 which surrounds the cylinder 4 and can be brought into flow communication with the internal space of the cylinder 4 via a damper valve or restrictor valve 6.

A damper piston 3 is seated axially displaceably in the cylinder 4 of the damper housing 2 and divides the internal space of the cylinder 4 into two cylinder chambers. As FIG. 1 shows, restrictor passages are formed in a manner known per se or corresponding valves are provided in the damper piston 3. The damper piston 3 is seated on a piston rod 7 which exits the cylinder 4 and the damper housing 2 at the one end and is guided longitudinally displaceably in the ring base section 8 terminating the damper housing 2. The end of the piston rod 7 exiting the damper housing 2 is provided with a socket-like damper support 9 and equally the oppositely disposed end face of the damper housing 2 is provided with such a socket-like damper support 10.

The path detection sensor 11 arranged in the interior space of the cylinder 4 includes a sensor head 12 which is received in the base 13 of the damper housing 2. As FIG. 1 shows, the base 13 of the damper housing 2 includes a central cut-out which is releasably closable axially by a base cover 14 to which the damper support 10 is fastened. If the screws 19 are loosened, the base cover 14 can be taken off and the sensor 12 removed.

A pick-up rod 15 is fastened to the sensor head 12 and extends coaxially to the piston rod 7 and is received in it. An axial bore 16 is provided for this purpose in the piston rod 7 so that the pick-up rod 15 can be moved into the piston rod 7. It us understood that the axial bore 16 has a sufficient length and a sufficient inner diameter in order also to ensure the reception of the pick-up rod 15 in the fully pushed-in position of the piston rod 7.

The pick-up rod 15 cooperates with a transducer 17 which is formed in sleeve shape in the drawn embodiment and is fastened to the piston rod 7 at the end thereof. The piston rod 7 projects beyond the piston 3 in the drawn embodiment. A holding sleeve 18, in which the transducer 17 is arranged, is screwed on the projecting piston rod stump. The transducer 17 is also releasably installed to allow it to be replaced separately from the movement damper 1.

As FIG. 1 shows, the pick-up rod 15 extends through the sleeve-shaped transducer 17. In every case, the arrangement is made such that the rod-shaped pick-up 15 can detect the position of the transducer 17 relative to it.

The pick-up rod and the transducer 17 can generally be made differently. In the embodiment drawn, the transducer 17 can, for example, be a magnetic sleeve, whereas the pick-up rod 15 is made as a winding rod with whose help a magnetic field change can be detected in dependence on the position of the transducer 17.

The pick-up rod 15 can, however, also be made in a different manner. It can, for example form a sound wave receiver/transmitter in the form of a thin wire so that transmitted sound waves can be reflected back by the sleeve-shaped transducer 17 and its position can be detected accordingly. The pick-up rod 15 can also cooperate with the transducer 17 according to the active principle of a potentiometer.

The signal picked up by the pick-up rod 15 can be converted into a corresponding sensor signal in an evaluation logic system, with the evaluation logic system being able to be arranged in the sensor head 12 and/or also outside the movement damper 1. The sensor head 12 is in communication with the desired signal processing device via a signal cable not shown in more detail.

1. A movement damper for vehicle chassis, in particular rail vehicles, comprising a damper housing (2) in which a damper piston (3) is movably received, wherein a sensor (11) for the detection of the movement and/or position of the damper piston (3) relative to the damper housing (2) is arranged in the interior of the damper housing (2).

2. A movement damper in accordance with claim 1, wherein the sensor (11) is received in the damper housing (2) in a separately removable manner.

3. A movement damper in accordance with claim 1, wherein the sensor (11) has a transducer (17) and a position encoder (15), of which the one is fastened to the damper housing (2) and the other is connected to the damper piston (3) so that a movement of the damper piston (3) relative to the damper housing (2) generates a corresponding movement of the transducer (17) relative to the position encoder (15).

4. A movement damper in accordance with claim 3, wherein the damper housing (2) forms a cylinder (4) in which the damper piston (3) connected to a piston rod (7) is longitudinally displaceable and in which the sensor (11) is received.

5. A movement damper in accordance with claim 4, wherein the position encoder (15) is fastened to an end-face base of the cylinder (4) and the transducer (17) is seated on the end face of the damper piston (3) and/or of the piston rod (7) connected thereto facing the base.

6. A movement damper in accordance with claim 1, wherein a piston rod (7) provided with an axial bore (16) is provided, and the sensor (11) has a pick-up rod (15) which is fastened to the damper housing (2) and can be moved into the axial bore (16) of the piston rod (7).

7. A movement damper in accordance with claim 6, wherein the pick-up-rod extends substantially over the total stroke of the damper piston (3) and/or the piston rod (7) connected thereto.

8. A movement damper in accordance with claim 7, wherein the transducer (17) has a sender sleeve which is seated on the piston rod (7) and which surrounds the pick-up rod (15).

9. A movement damper in accordance with claim 1, wherein the sensor (11) has a sensor head (12) which is received in the interior of the damper housing (2) and is preferably seated at the end-face base of the damper housing (3) and in which an evaluation unit is arranged and/or to which a signal lead can be connected.

10. A movement damper in accordance with claim 3, wherein the position encoder (15) is fastened to an end-face base of the cylinder (4) and the transducer (17) is seated on the end face of the damper piston (3) and/or of the piston rod (7) connected thereto facing the base.

11. A movement damper in accordance with claim 6, wherein the transducer (17) has a sender sleeve which is seated on the piston rod (7) and which surrounds the pick-up rod (15).

12. A movement damper in accordance with claim 2, wherein the sensor (11) has a transducer (17) and a position encoder (15), of which the one is fastened to the damper housing (2) and the other is connected to the damper piston (3) so that a movement of the damper piston (3) relative to the damper housing (2) generates a corresponding movement of the transducer (17) relative to the position encoder (15).

13. A movement damper in accordance with claim 12, wherein the damper housing (2) forms a cylinder (4) in which the damper piston (3) connected to a piston rod (7) is longitudinally displaceable and in which the sensor (11) is received.

14. A movement damper in accordance with claim 13, wherein the position encoder (15) is fastened to an end-face base of the cylinder (4) and the transducer (17) is seated on the end face of the damper piston (3) and/or of the piston rod (7) connected thereto facing the base.

15. A movement damper in accordance with claim 12, wherein the position encoder (15) is fastened to an end-face base of the cylinder (4) and the transducer (17) is seated on the end face of the damper piston (3) and/or of the piston rod (7) connected thereto facing the base.

16. A movement damper in accordance with claim 2, wherein a piston rod (7) provided with an axial bore (16) is provided, and the sensor (11) has a pick-up rod (15) which is fastened to the damper housing (2) and can be moved into the axial bore (16) of the piston rod (7).

17. A movement damper in accordance with claim 3, wherein a piston rod (7) provided with an axial bore (16) is provided, and the sensor (11) has a pick-up rod (15) which is fastened to the damper housing (2) and can be moved into the axial bore (16) of the piston rod (7).

18. A movement damper in accordance with claim 4, wherein a piston rod (7) provided with an axial bore (16) is provided, and the sensor (11) has a pick-up rod (15) which is fastened to the damper housing (2) and can be moved into the axial bore (16) of the piston rod (7).

19. A movement damper in accordance with claim 5, wherein a piston rod (7) provided with an axial bore (16) is provided, and the sensor (11) has a pick-up rod (15) which is fastened to the damper housing (2) and can be moved into the axial bore (16) of the piston rod (7).

20. A movement damper in accordance with claim 12, wherein a piston rod (7) provided with an axial bore (16) is provided, and the sensor (11) has a pick-up rod (15) which is fastened to the damper housing (2) and can be moved into the axial bore (16) of the piston rod (7).
